(19) United States
(12) Patent Application Publication
(10) Pub. No.: US 2005/0060890 A1
(43) Pub. Date: Mar. 24, 2005

(54) Method and apparatus for attaching and detaching two utensils

(76) Inventor: Victor W. Lee, Livingston, NJ (US)

Correspondence Address: Mr. Walter J. Tencza Jr.;Suite 3, 10 Station Place, Metuchen, NJ, 08840, US

(21) Appl. No.: 10/665,926

(22) Filed: Sep. 19, 2003

(51) Int. Cl. B26B 1/02

(52) U.S. Cl. 30/155; 30/151

(57) ABSTRACT

An apparatus is provided comprising a first knife and a second knife. The first knife typically includes a first attachment device and the second knife includes a second attachment device to attach the two knives together. The first and second attachment devices can be detached to detach the two knives from each other. The first and second knives can be folding type knives. The first attachment device may be comprised of a first plate having an opening. The second attachment device may be comprised of a protrusion. The protrusion of the second attachment device can be inserted into the opening of the first plate to attach the first knife to the second knife.

### FIELD OF THE INVENTION

This invention relates to improved methods and apparatus concerning utensils.

### BACKGROUND OF THE INVENTION

Typically in the prior art utensils, such as forks or knives, are provided separate from each other. There are holders, which are known in the art such as holder 6 in U.S. Pat. No. 2,753,631 to Culver for holding two knifes. However, the knives shown in Culver, must be removed from the holder 6 in order to be used. The holder 6 is not part of the knives. There are folding type knives, which include various tools, such as disclosed in U.S. Pat. No. 927,352 to Hoglund et al. The tools in the folding type knives typically can rotate into an open or closed position but cannot be detached from the knife.

### SUMMARY OF THE INVENTION

The present invention in one or more embodiments provides an apparatus comprising a first utensil and a second utensil, such as a first knife and a second knife. The first knife typically includes a first attachment device and the second knife typically includes a second attachment device, wherein the first attachment device and the second attachment device can be attached to each other to attach the first knife to the second knife. The first attachment device and the second attachment device can be easily detached from each other to detach the first knife from the second knife. The first and second knives may be folding type knives.

The first knife may be comprised of first and second blades, and the second knife may be comprised of third and fourth blades. The first attachment device may be comprised of a first plate having an opening. The second attachment device may be comprised of a protrusion. The protrusion of the second attachment device can be inserted into the opening of the first plate to attach the first knife to the second knife. The second attachment device may be comprised of a second plate attached to the protrusion.

The first attachment device may also be comprised of a third plate having an opening, which is substantially aligned with the opening of the first plate. The protrusion typically can be inserted into the opening of the third plate to attach the first knife to the second knife. The opening in the first plate of the first attachment device may have a first substantially rectangular portion, a substantially circular portion, and a second substantially rectangular portion. First and second protruding stops may be provided which protrude into the opening of the third plate of the first attachment device and prevent the first knife from rotating more than one hundred and eighty degrees with respect to the second knife, after the second knife is attached to the first knife.

The first and second blades may be able to rotate from a closed position within the first knife to an open position. The third and fourth blades may be able to rotate from a closed position within the first knife to an open position. The first knife may have a clip.

The second attachment device may be inserted into the first attachment device, when the first knife is place at an angle with respect to the second knife. The first knife may be rotated with respect to the second knife to cause the first and second knife to lock in a state of alignment with respect to each other. First and second rotating balls may be attached to the first plate of the first attachment device, so that the balls can rotate but remain in the same position. The second plate may include a first ball opening and a second ball opening. The first rotating ball can be inserted into the first ball opening and the second rotating ball can be inserted into the second ball opening in order to lock the first knife in a first position with respect to the second knife. The second plate may include a third ball opening and a fourth ball opening. The first rotating ball can be inserted into the third ball opening and the second rotating ball can be inserted into the fourth ball opening in order to lock the first knife in a second position with respect to the second knife, wherein the first position differs from the second position.

The present invention in one or more embodiments also includes a method comprising attaching a first attachment device of a first knife to a second attachment device of a second knife, in order to attach the first knife and the second knife together, and thereafter detaching the first attachment device from the second attachment device to detach the first knife from the second knife.

### BRIEF DESCRIPTION OF THE DRAWINGS

FIG. 1A shows a bottom view of a first knife in accordance with an embodiment of the present invention, with the first knife in a closed state;

FIG. 1B shows a top view of the first knife of FIG. 1A, with the first knife in a closed state;

FIG. 2A shows a rear view of the first knife of FIG. 1A, with the first knife in a closed state;

FIG. 2B shows a front view of the first knife of FIG. 1A, with the first knife in a closed state;

FIG. 3A shows a right side view of the first knife of FIG. 1A, with the first knife in a closed state;

FIG. 3B shows a left side view of the first knife of FIG. 1A, with the first knife in a closed state;

FIG. 4A shows a right side view of the first knife of FIG. 1A with a first blade of the first knife in an open state;

FIG. 4B shows a left side view of the first knife of FIG. 1A with a second blade of the first knife in an open state;

FIG. 5A shows a bottom view of a second knife in accordance with an embodiment of the present invention, with the second knife in a closed state;

FIG. 5B shows a top view of the second knife of FIG. 5A, with the second knife in a closed state;

FIG. 6A shows a rear view of the second knife of FIG. 5A, with the second knife in a closed state;

FIG. 6B shows a front view of the second knife of FIG. 5A, with the second knife in a closed state;

FIG. 7A shows a right side view of the second knife of FIG. 5A, with the second knife in a closed state;

FIG. 7B shows a left side view of the second knife of FIG. 5A, with the second knife in a closed state;

FIG. 8A shows a right side view of the second knife of FIG. 5A with a first blade of the second knife in an open state;

FIG. 8B shows a left side view of the second knife of FIG. 5A with a second blade of the second knife in an open state;

FIG. 9A is a diagram showing the second knife of FIGS. 5A-8B placed on top of the first knife of FIGS. 1A-4B, in a first orientation;

FIG. 9B shows a top view of the second knife and a location of portions of the second knife used to connect the first knife to the second knife;

FIG. 9C shows a top view of the second knife and a location of portions of the first knife used to connect the first knife to the second knife;

FIG. 9D shows a top view of the second knife and a location of portions of the first knife and portions of the second knife which are used to connect the first knife and the second knife together;

FIG. 10A is a diagram showing the second knife of FIGS. 5A-8B placed on top of the first knife of FIGS. 1A-4B, in a second orientation;

FIG. 10B shows a top view of the second knife and a location of portions of the second knife used to connect the first knife;

FIG. 10C shows a top view of the second knife and a location of portions of the first knife used to connect the first knife to the second knife;

FIG. 10D shows a top view of the second knife and a location of portions of the first knife and portions of the second knife which are used to connect the first knife and the second knife together;

FIG. 11 shows the second knife placed on top of the first knife, with the left side of the first knife visible and the left side of the second knife visible, and with dashed lines showing the locations of first and second balls from the first knife and a protrusion from the second knife;

FIG. 12A shows a top view of a first plate and a second plate of the first knife;

FIG. 12B shows a bottom view of the first plate and the second plate of the first knife;

FIG. 13A shows a top view of a third plate and a fourth plate of the first knife, with dashed lines showing various locations for the protrusion of the second knife to be inserted into the third plate;

FIG. 13B shows a bottom view of the third plate and the fourth plate of the first knife;

FIG. 14A shows a top view of a first plate and a second plate of the second knife;

FIG. 14B shows a bottom view of the first plate and the second plate of the second knife;

FIG. 15A shows a top view of a third plate and a fourth plate of the second knife;

FIG. 15B shows a bottom view of the third plate and the fourth plate of the second knife;

FIG. 16 shows a top view of components of the first knife taken apart; and

FIG. 17 shows a top view of components of the second knife taken apart.

### DETAILED DESCRIPTION OF THE DRAWINGS

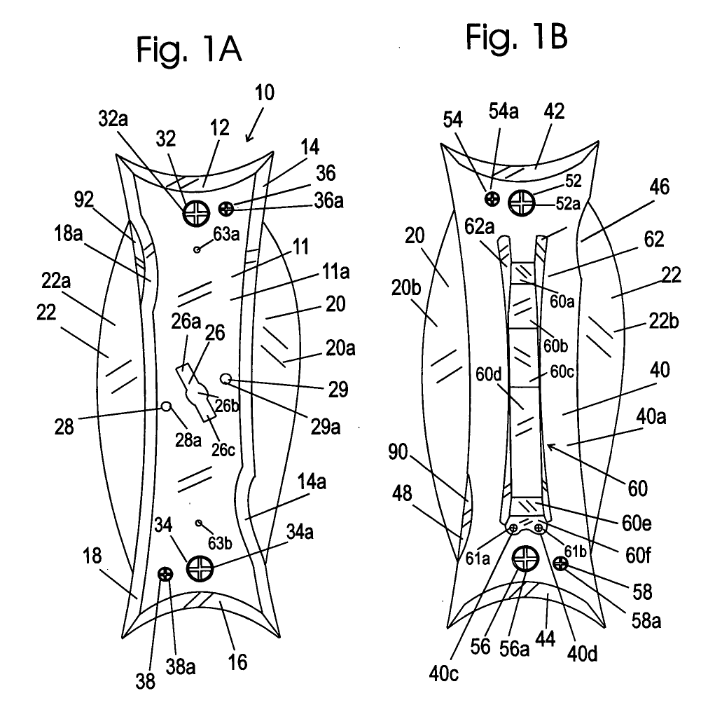

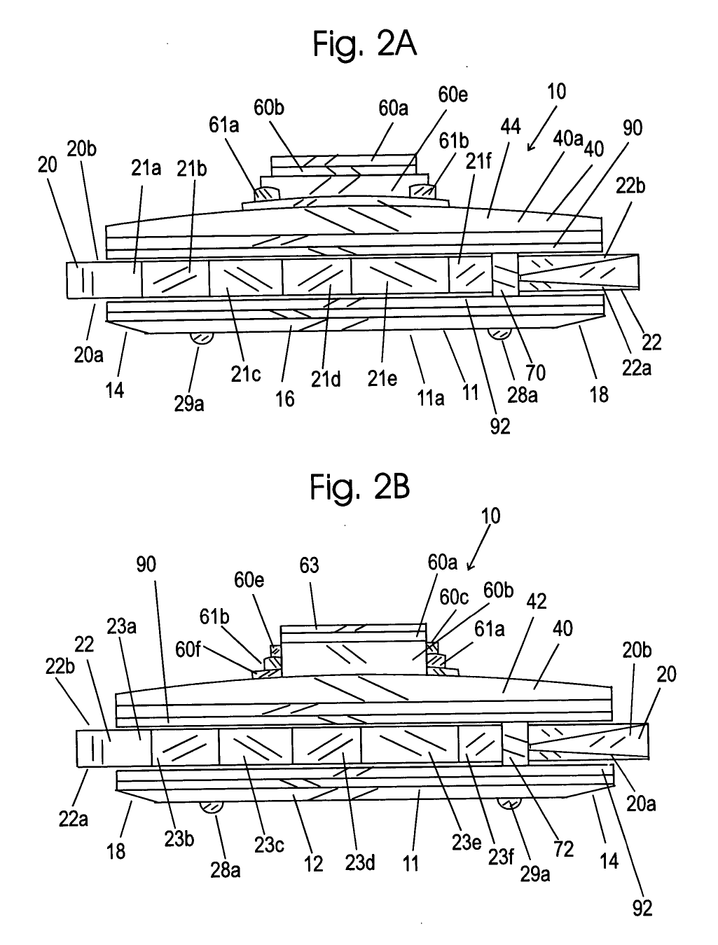

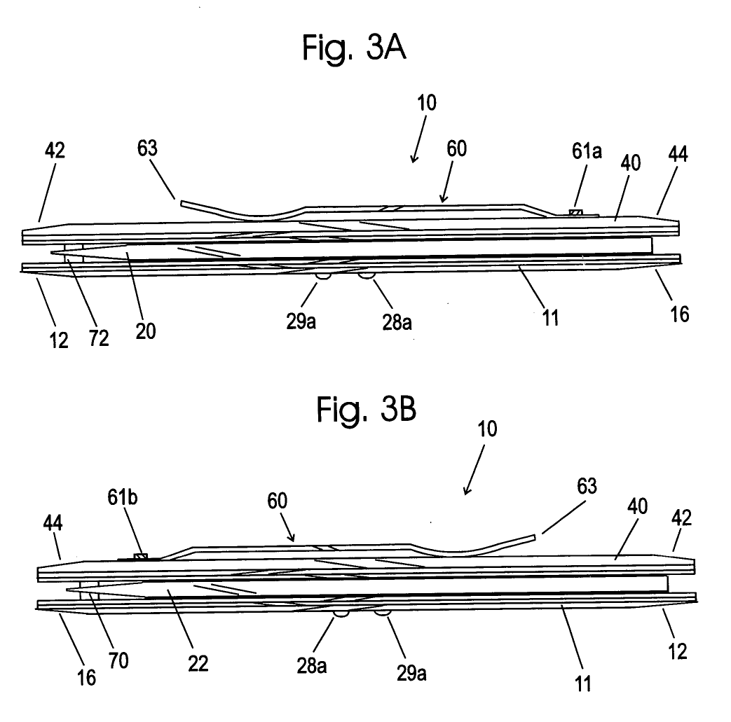

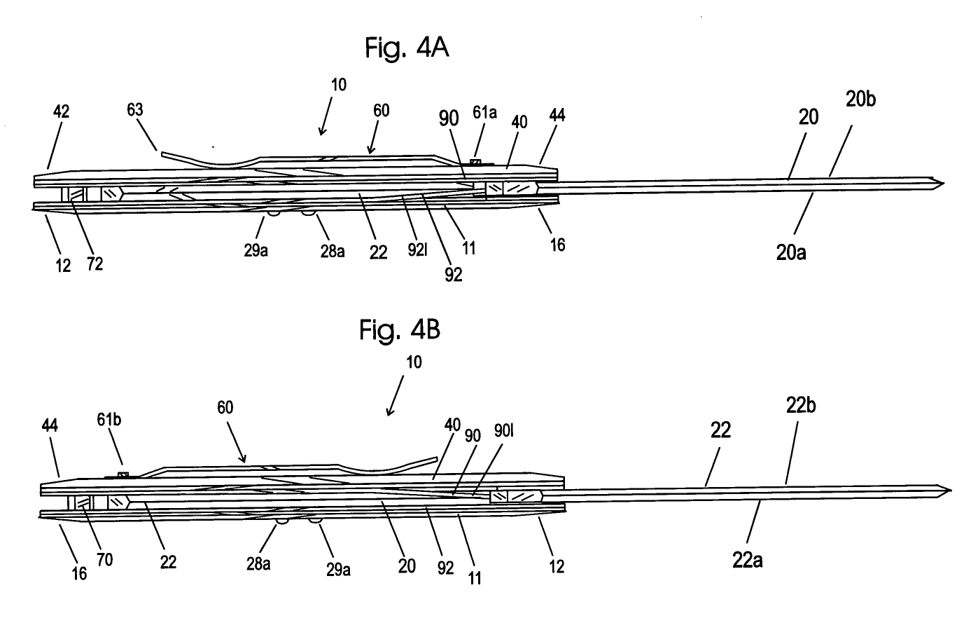

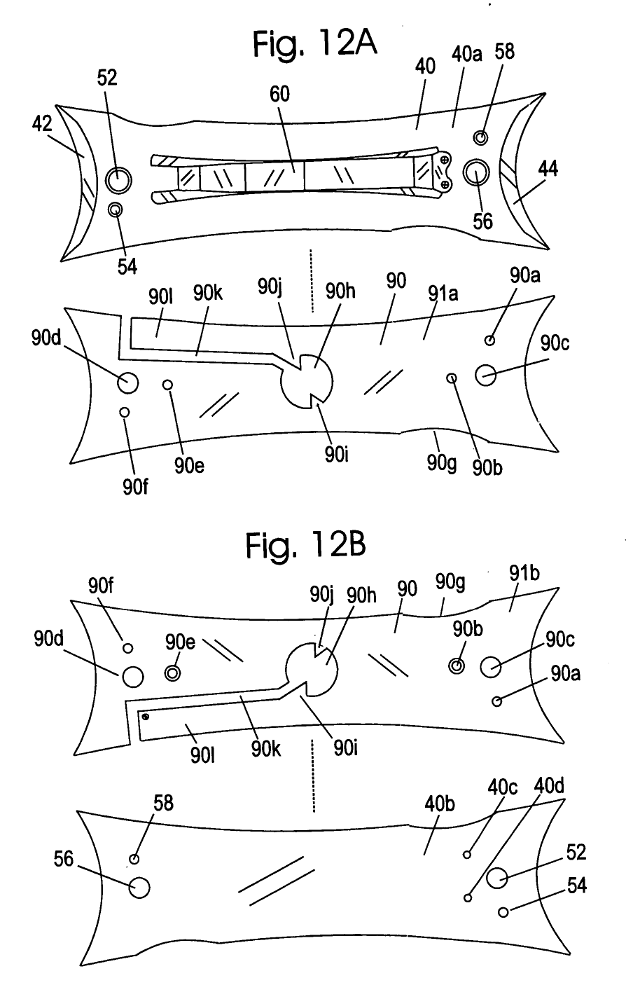

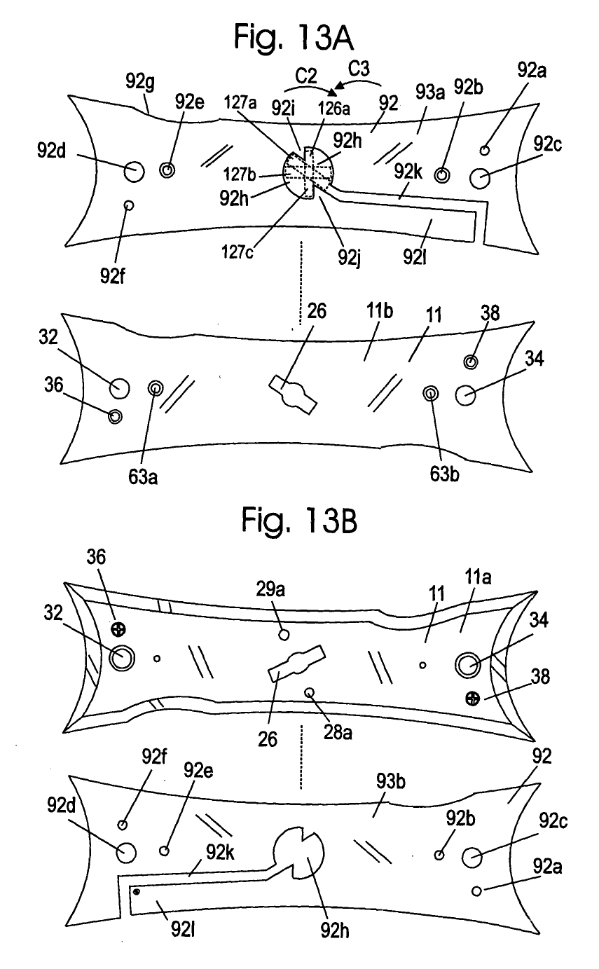

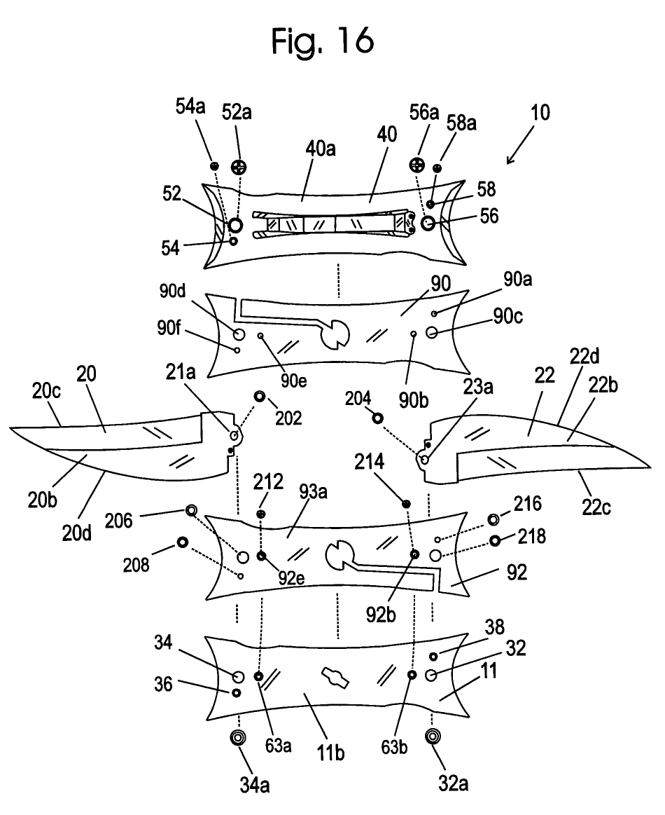

FIGS. 1A, 1B, 2A, 2B, 3A, and 3B show bottom, top, rear, front, right side, and left side views, respectively of a first knife 10, in accordance with an embodiment of the present invention, wherein the first knife 10 is in a closed state. FIGS. 4A and 4B show right and left side views of the first knife 10 with a first blade 20 and a second blade 22, respectively, in an open state. FIGS. 12A-12B show top and bottom views of a first or top plate 40 and a second plate 90 respectively, of the first knife 10. FIGS. 13A-13B show top and bottom views of a third plate 92 and a fourth or bottom plate 11 respectively, of the first knife 10. FIG. 16 shows a top view of the first knife 10 taken apart.

Referring to FIGS. 1A-4B, 12A-13B, and 16, the first knife 10 includes the first or top plate 40, the second plate 90, the blade 20, the blade 22, the third plate 92, and the fourth or bottom plate 11.

The first or top plate 40 has a surface 40a shown in FIG. 1B and FIG. 12A and a surface 40b shown in FIG. 12B. The surface 40a of the top plate 40 includes tapered fringes or portions 42 and 44. The plate 40 includes indented portions 46 and 48. The top plate 40 has openings 52, 54, 56, 58, and 40c and 40d through which screws can be inserted. A clip 60 is fixed to the top plate 40. The clip 60 has portions 60a, 60b, 60c, 60d, 60e, and 60f. The clip 60 is fixed to the surface 40a by screws 61a and 61b through openings 40c and 40d, respectively. The openings 40c and 40d may be delimited by inner surfaces of the plate 40 which may be threaded.

The second plate 90 has surfaces 91a and 91b shown in FIGS. 12A and 12B, respectively. The second plate 90 has openings 90a, 90b, 90c, 90d, 90e, and 90f. The second plate 90 has an indented portion 90g. The second plate 90 has a central opening 90h. Protruding stops or triangular portions 90i and 90j protrude into the opening 90h. There is a flexed portion 90l, which is separated from the adjacent part of the second plate 90 by a channel 90k. The flexed portion 90l as shown in FIG. 12A, may be flexed or biased downwards in a direction into the page.

The blade 20 has a surface 20a, a surface 20b, a cutting edge 20c, and a non-cutting edge 20d. The non-cutting edge 20d is typically thicker than the cutting edge 20c. The blade 20 also has a hole 21a. The blade 22 similarly has a surface 22a, a surface 22b, a cutting edge 22c, and a non-cutting edge 22d. The non-cutting edge 22d is typically thicker than the cutting edge 22c. The blade 20 also has a hole 23a.

The third plate 92 may be substantially similar to the second plate 90. The third plate has surfaces 93a and 93b shown in FIGS. 13A and 13B. The third plate 92 has openings 92a, 92b, 92c, 92d, 92e, and 92f. The third plate 92 has an indented portion 92g. The third plate 92 has a central opening 92h. Protruding stops or triangular portions 92i and 92j protrude into the opening 92h. There is a flexed portion 92l, which is separated from the adjacent part of the second plate 92 by a channel 92k. The flexed portion 92l as shown in FIG. 13A, may be flexed or biased upwards in a direction out of the page.

The bottom plate 11 has a surface 1a shown in FIG. 1A and FIG. 13B. The surface 1a of the bottom plate 11 includes tapered fringes or portions 12, 14, 16, and 18. The fringe portion 14 has an indented portion 14a. The fringe portion 18 has an indented portion 18a. The bottom plate 11 has a substantially centrally located opening 26 having a substantially rectangular portion 26a, a substantially circular portion 26b, and a substantially rectangular portion 26c. The bottom plate 11 also includes metal balls 28a and 29a, which can rotate within openings 28 and 29, respectively. The plate 11, including key shaped opening 26 and balls 28a and 29a may be considered an attachment device for attaching the knife 10 to a knife 100. The bottom plate 11 has openings 32, 34, 63a and 63b through which screws can be inserted. The bottom plate 11 also has posts 36 and 38 fixed to it, which have threaded openings for insertion of screws.

Referring to FIG. 16, the first knife 10 may be assembled as follows. The plate 92 may be placed and aligned over the plate 11 so that the surface 93b of the plate 92 contacts the surface 11b of the plate 11. The plate 92 may then be secured to the plate 11 by attaching a threaded end of screw 212 through openings 92e and 63a and a threaded end of screw 214 through openings 92b and 63b. Post screws 34a and 32a can be inserted through openings 34 and 32, respectively, up through the surface 11a through plate 11 and then through the surface 11b. Washers 206 and 208 can be placed on post screw 34a and on post 36, respectively. Washers 216 and 218 can be placed on post 38 and on post screw 32a. The blade 20 can be placed on top of the plate 92, so that the surface 20a of the blade 20 is adjacent to the surface 93a of the plate 92 and a portion of the post 34a is inserted through the hole 21a of the blade 20. This allows the blade 20 to rotate using the post 34a as a pivot point. Similarly, the blade 22 can be placed on top of the plate 92, so that the surface 22a of the blade 22 is adjacent to the surface 93a of the plate 92 and a portion of the post 32a is inserted through the hole 23a of the blade 22. This allows the blade 22 to rotate using the post 32a as a pivot point.

A washer 202 is placed over the blade 20 so that a portion of the post 34a is inserted into the washer 202. Similarly a washer 204 is placed over the blade 22 so that a portion of the post 32a is inserted into the washer 204. Next the plate 90 is placed and aligned over the plate 92, with the blades 20 and 22 in between the plate 90 and the plate 92. Part of the post 34a is inserted through the opening 90d in the plate 90 and part of the post 32a is inserted through the opening 90c. Part of the post 36 is inserted through the opening 90f and part of the post 38 is inserted through the opening 90a. Next, the plate 40 is placed and aligned over the plate 92. Part of the post 34a is inserted into the opening 52, part of the post 32a is inserted through the opening 56, part of the post 36 is inserted through the opening 54 and part of the post 38 in inserted through the opening 58. Screw 52a is inserted into the opening 52 and connected to the post 34a, screw 54a is inserted into the opening 54 and connected to the post 36, screw 56a is inserted into the opening 56 and connected to the post 32a, and screw 58a is inserted into the opening 58 and connected to the post 38.

When fully assembled the first knife 10 operates as follows. Each of the blades 20 and 22 can be placed in a closed state as shown in FIGS. 1A-3B, or in an open state as shown by FIGS. 4A and 4B. The blades 20 and 22 may both be open at the same time. When the blade 20 is in the fully open state shown in FIG. 4A, the portion 92l of the plate 92 flexes inward towards the plate 40 and thereby contacts the blade 20, keeping the blade 20 in the open position. The portion 92l is biased or flexed so that when the blade 20 is not pressing down on it, it flexes toward the plate 40. The blade 20 can only be placed back in the closed position by pushing the portion 92l plate 92 (i.e. portion 92l) back downwards towards the plate 11, allowing the blade 20 to slide over and press down on the plate 92. Similarly, when the blade 22 is in the fully open state shown in FIG. 4B, the portion 90l of plate 90 flexes inward towards the plate 11 and thereby contacts the blade 22 keeping the blade 22 in the open position. The portion 90l is biased or flexed so that when the blade 22 is not pressing down on it, it flexes toward the plate 11. The blade 22 can only be placed back in the closed position by pushing the portion 90l of the plate 90 back downwards towards the plate 40, allowing the blade 22 to slide over and press down on the plate 90.

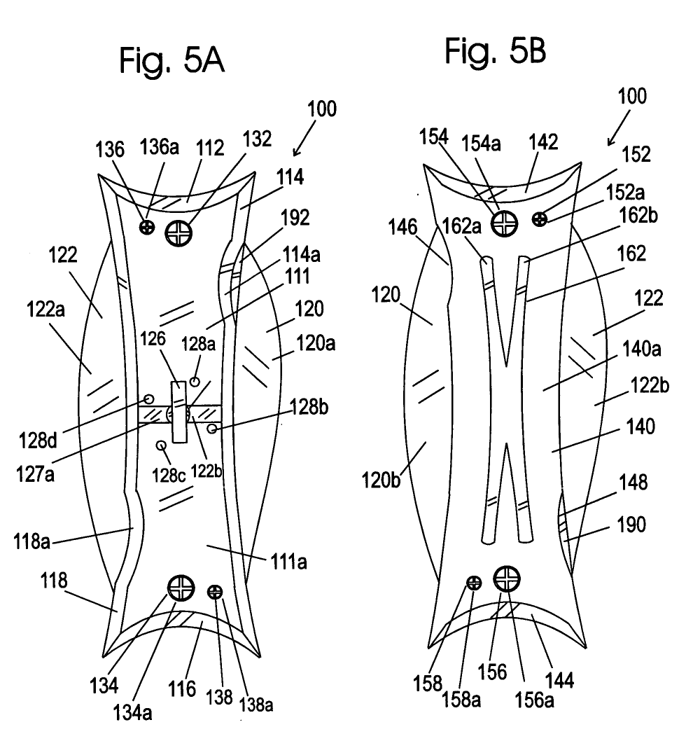

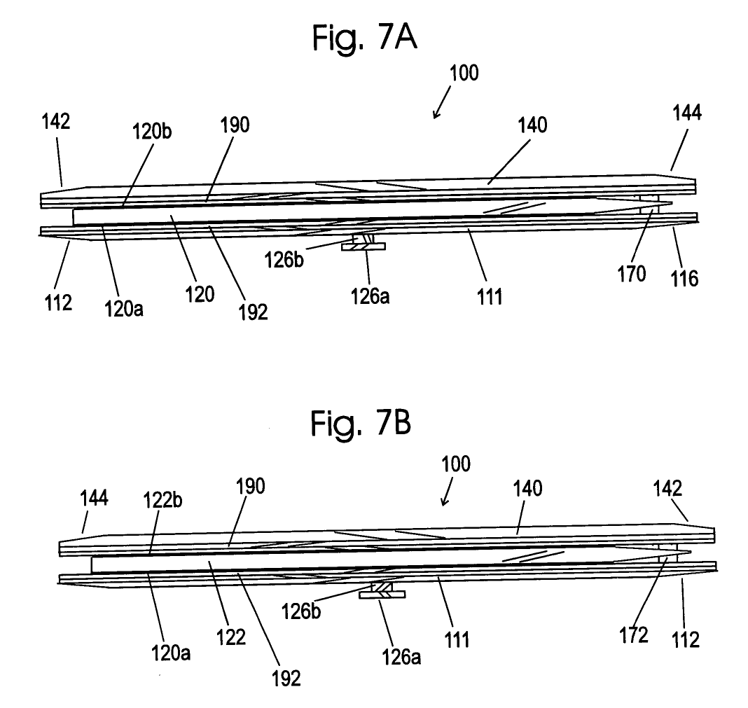

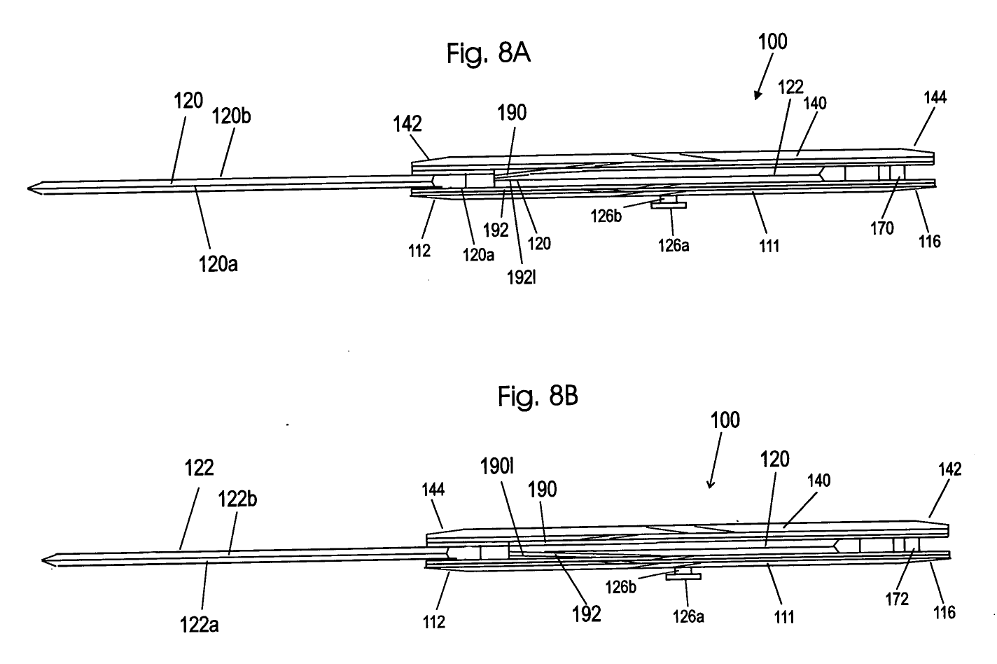

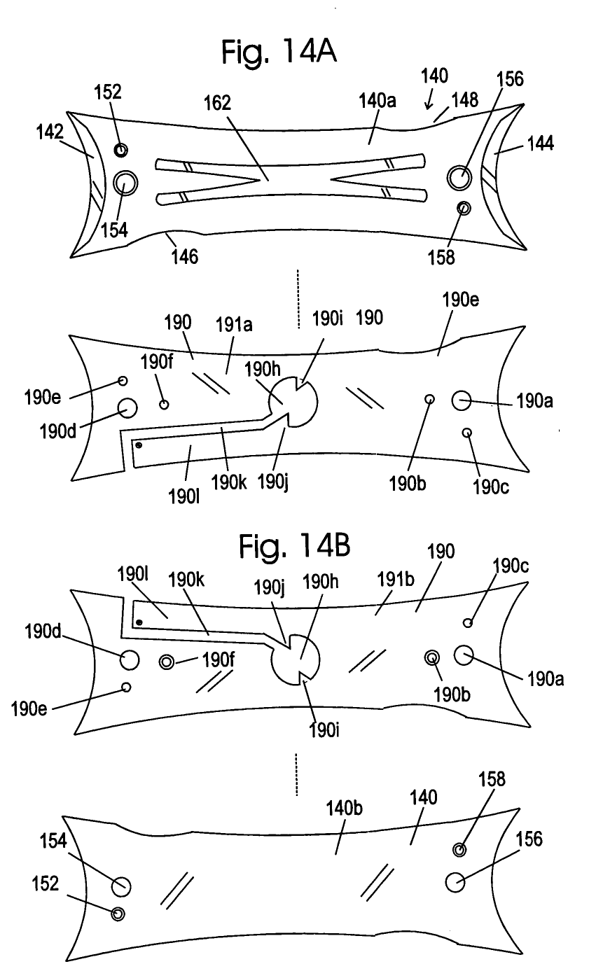

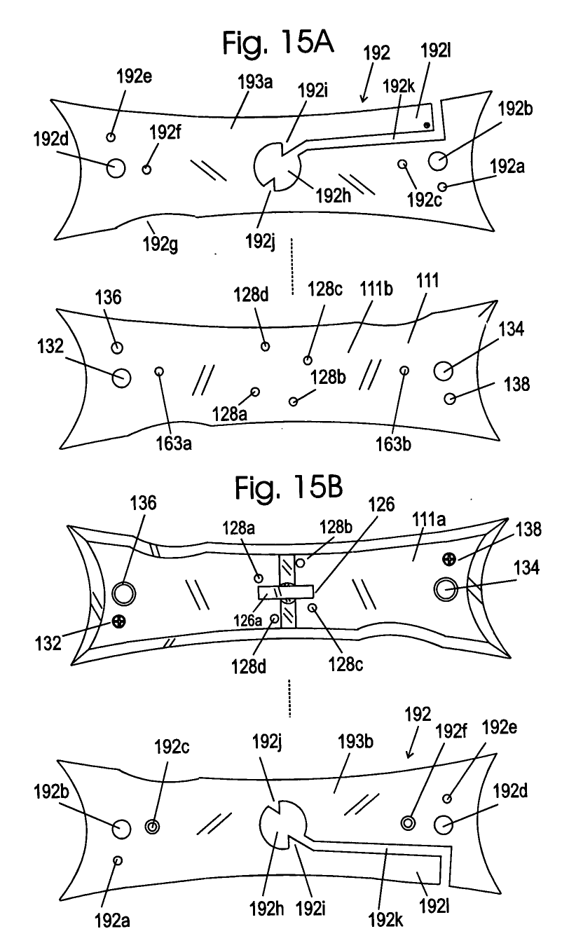

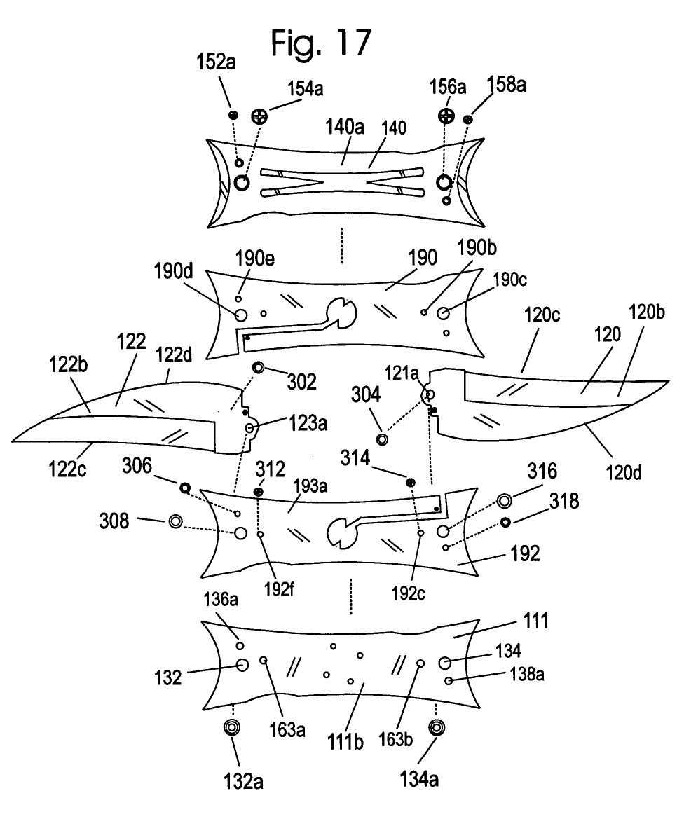

FIGS. 5A, 5B, 6A, 6B, 7A, and 7B show bottom, top, rear, front, right side, and left side views, respectively of a second knife 100, in accordance with an embodiment of the present invention, wherein the second knife 100 is in a closed state. FIGS. 8A and 8B show right and left side views of the second knife 100 with a first blade 120 and a second blade 122, respectively, in an open state. FIGS. 14A-14B show top and bottom views of a first plate 140 and a second plate 190 respectively, of the second knife 100. FIGS. 15A-15B show top and bottom views of a third plate 192 and a fourth plate 111, respectively, of the second knife 100. FIG. 17 shows a top view of the first knife 100 taken apart.

Referring to FIGS. 5A-8B, 14A-15B, and 17, the second knife 100 includes the first or top plate 140, the second plate 190, the blade 120, the blade 122, the third plate 192 and the fourth or bottom plate 111.

The first or top plate 140 has a surface 140a shown in FIG. 5B and FIG. 14A and a surface 40b shown in FIG. 14B. The surface 140a of the top plate 140 includes tapered fringes or portions 142 and 144. The plate 140 includes indented portions 146 and 148. The top plate 140 has openings 152, 154, 156, and 158 through which screws can be inserted. The top plate 140 has a rubber portion 162 comprised of portions 162a and 162b.

The second plate 190 has surfaces 191a and 191b shown by FIGS. 15A and 15B, respectively. The second plate 190 has openings 190a, 190b, 190c, 190d, 190e, and 190f. The second plate 190 has an indented portion 190g. The second plate 190 has a central opening 190h. Protruding stops or triangular portions 190i and 190j protrude into the opening 190h. There is a flexed portion 190l, which is separated from the adjacent part of the second plate 190 by a channel 190k. The flexed portion 190l as shown in FIG. 14A, may be flexed or biased downwards in a direction into the page.

The blade 120 has a surface 120a, a surface 120b, a cutting edge 120c, and a non-cutting edge 120d. The non-cutting edge 120d is typically thicker than the cutting edge 120c. The blade 120 also has a hole 121a. The blade 122 similarly has a surface 122a, a surface 122b, a cutting edge 122c, and a non-cutting edge 122d. The non-cutting edge 122d is typically thicker than the cutting edge 122c. The blade 120 also has a hole 123a.

The third plate 192 may be substantially similar to the second plate 190. The third plate has surfaces 193a and 193b shown in FIGS. 15A and 15B, respectively. The third plate 192 has openings 192a, 192b, 192c, 192d, 192e, and 192f. The third plate 192 has an indented portion 192g. The third plate 192 has a central opening 192h. Protruding stops or triangular portions 192i and 192j protrude into the opening 192h. There is a flexed portion 192l, which is separated from the adjacent part of the second plate 192 by a channel 192k. The flexed portion 192l as shown in FIG. 15A, may be flexed or biased upwards in a direction out of the page.

The bottom plate 111 has a surface 111a shown in FIG. 5A and FIG. 15B. The surface 111a of the bottom plate 111 includes tapered fringes or portions 112, 114, 116, and 118. The fringe portion 114 has an indented portion 114a. The fringe portion 118 has an indented portion 118a. The bottom plate 111 has a substantially centrally located protrusion 126 having a substantially rectangular portion 126a attached to a substantially cylindrical portion 126b. The bottom plate 111 also has openings 128a, 128b, 128c and 128d. surrounding the protrusion 126. The bottom plate 111, including the protrusion 126 and openings 128a-d, may be considered an attachment device for attaching the first knife 10 to the second knife 100. The bottom plate 111 also has openings 132, 134, 136, 138, 163a and 163b, through which screws can be inserted. The bottom plate 111 also has posts 136a and 138a fixed to it, which have threaded openings for insertion of screws.

Referring to FIG. 17, the second knife 100 may be assembled as follows. The plate 192 may be placed and aligned over the plate 111 so that the surface 193b of the plate 192 contacts the surface 111b of the plate 11. The plate 192 may then be secured to the plate 111 by attaching a threaded end of screw 312 through openings 192f and 163a and a threaded end of screw 314 through openings 192c and 163b. Post screws 134a and 132a can be inserted through openings 134 and 132, respectively, up through the surface 111a through plate 111 and then through the surface 111b. Washers 306 and 308 can be placed on post screw 132a and on post 136a, respectively. Washers 316 and 318 can be placed on post 138a and on post screw 134a. The blade 120 can be placed on top of the plate 192, so that the surface 120a of the blade 120 is adjacent to the surface 193a of the plate 192 and a portion of the post 134a is inserted through the hole 121a of the blade 120. This allows the blade 120 to rotate using the post 134a as a pivot point. Similarly, the blade 122 can be placed on top of the plate 192, so that the surface 122a of the blade 122 is adjacent to the surface 193a of the plate 192 and a portion of the post 132a is inserted through the hole 123a of the blade 122. This allows the blade 122 to rotate using the post 132a as a pivot point.

A washer 304 is placed over the blade 120 so that a portion of the post 134a is inserted into the washer 304. Similarly a washer 302 is placed over the blade 122 so that a portion of the post 132a is inserted into the washer 302. Next the plate 190 is placed and aligned over the plate 192, with the blades 120 and 122 in between the plate 190 and the plate 192. Part of the post 134a is inserted through the opening 190c in the plate 190 and part of the post 132a is inserted through the opening 190d. Part of the post 136a is inserted through the opening 190e and part of the post 138a is inserted through the opening 190b. Next, the plate 140 is placed and aligned over the plate 192. Part of the post 134a is inserted into the opening 156, part of the post 132a is inserted through the opening 154, part of the post 136a is inserted through the opening 152 and part of the post 138a in inserted through the opening 158. Screw 152a is inserted into the opening 152 and connected to the post 136a, screw 154a is inserted into the opening 154 and connected to the post 132a, screw 156a is inserted into the opening 156 and connected to the post 134a, and screw 158a is inserted into the opening 158 and connected to the post 138a.

When fully assembled the second knife 100 operates as follows. Each of the blades 120 and 122 can be placed in a closed state as shown in FIGS. 5A-7B, or in an open state as shown by FIGS. 8A and 8B. The blades 120 and 122 may both be in an open state at the same time. When the blade 120 is in the fully open state shown in FIG. 8A, the portion 190l of the plate 190 flexes inward towards the plate 192 and thereby contacts the blade 120 keeping the blade 120 in the open position. The blade 120 can only be placed back in the closed position by pushing portion 190l of the plate 190 back upwards towards the plate 140, allowing the blade 120 to slide under the plate 190. Similarly, when the blade 122 is in the fully open state shown in FIG. 4B, the plate 192 flexes towards the plate 190 and thereby contacts the blade 122 keeping the blade 122 in the open position. The blade 122 can only be placed back in the closed position by pushing the portion 192l of the plate 192 back downwards towards the plate 111, allowing the blade 122 to slide over the plate 192.

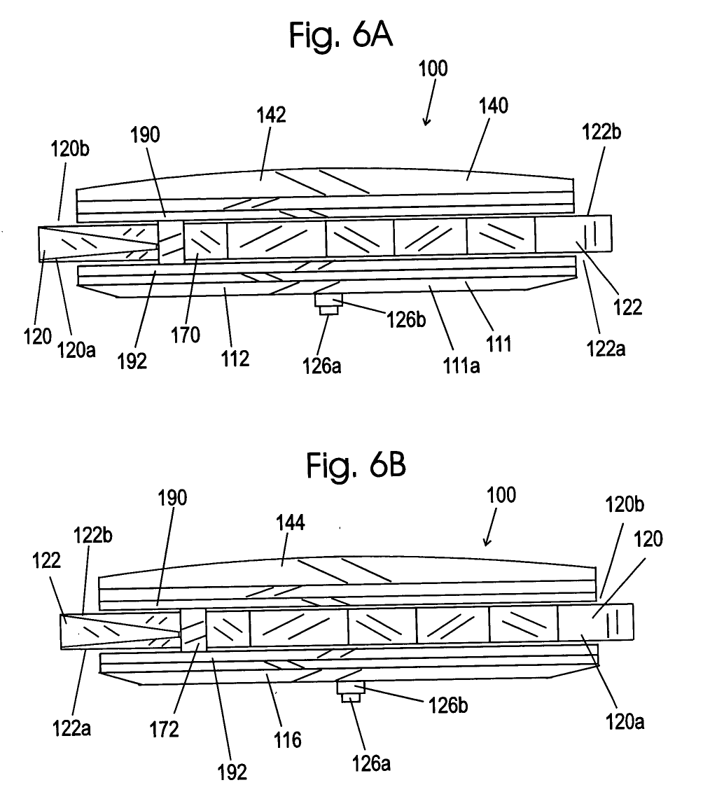

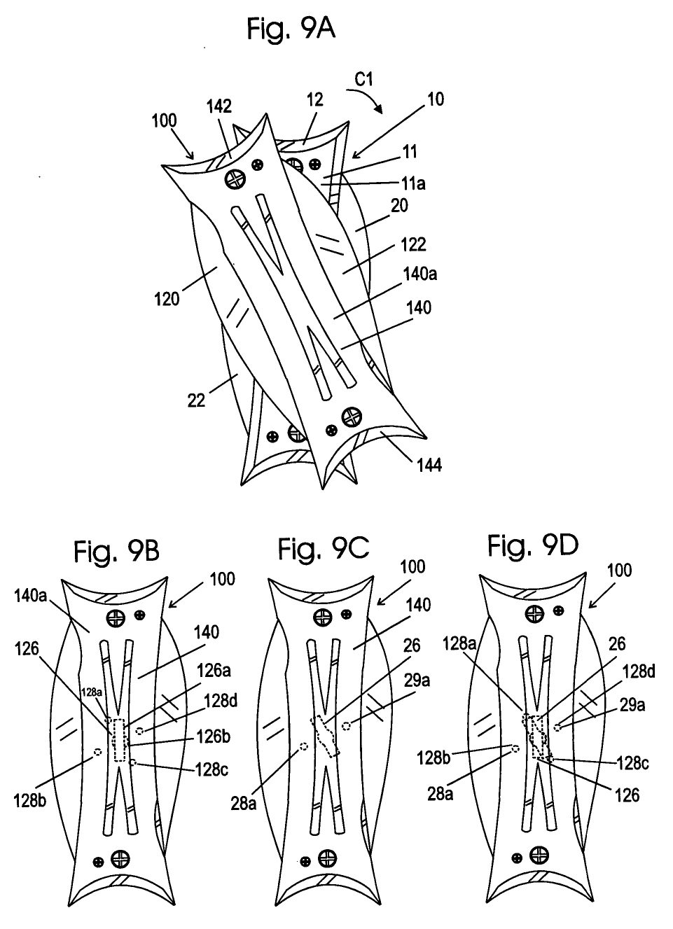

FIGS. 9A-9D, 10A-10D, FIG. 11, and FIG. 13A will help to explain how the first knife 10 and the second knife 100 can be attached together. The second knife 100 may be placed over the first knife 10 as shown by FIG. 9A. In the orientation of FIG. 9A, the portion 142 of the second knife 100 is closer to the portion 12 of the first knife 10 than the portion 144. The second knife 100 is placed at an angle with respect to the first knife 10 so that the protruding portion 126 shown by FIGS. 5A, 6A-B, 7A-7B, 8A-8B, can be inserted into the opening 26 shown in FIGS. 1A, 13A and 13B. Rectangular portion 126a fits snugly into the opening 26 and cylindrical portion of the protrusion 126 fits snugly in the circular portion 26b. The rectangular portion 126a is inserted so that it will go through the plate 11 and will lie in the opening 92h of the plate 92 shown in FIG. 13A. When the rectangular portion 126a is in the opening 92h, the rectangular portion 126a, and thus the second knife 100, can be rotated to a limited extent with respect to the first knife 10. Referring to FIG. 13A, the rectangular portion 126a can be placed a position 127a, shown by dashed lines, where the rectangular portion 126a cannot rotate any further in the direction C2 within the opening 92h because the portion 126a abuts against stops 92i and 92j. The rectangular portion 126a and the knife 100, can be rotated in the opposite direction C3, to a position 127b. In this position, the knifes 10 and 100 are aligned. The rectangular portion 126a can be rotated further in the direction C3 to a position 127c where the rectangular portion 126a again abuts the stops 92i and 92j and cannot rotate any further in the direction C3.

After the protruding portion 126 has been inserted into the opening 26 the knife 100 can be rotated clockwise in a direction C1, shown by FIG. 9A, while the first knife 10 remains stationary. The second knife 100 is rotated in the clockwise direction C1, until knife 100 is aligned over the first knife 10 (note that the rectangular portion 126a as shown by the view of FIG. 13A would move in the opposite direction in FIG. 13A since knife 10 is flipped when connected to knife 100), so that only the second knife 100 can be seen from a top view of the top surface 140a of the top plate 140 of the second knife 100, as shown by FIG. 9B. When aligned, the rectangular portion 126a would be in position 127b in the plate 92 as shown by dashed lines in FIG. 13A.

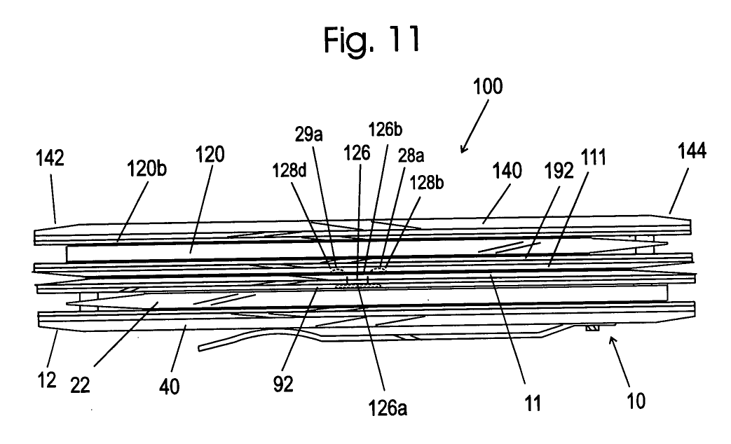

As shown by FIGS. 9B-9D, and 11, the knives 100 and 10 snap together in a position of alignment. FIG. 9B shows by dashed lines, the orientation of protruding portion 126 and openings 128a-d after alignment of knives 10 and 100. FIG. 9C shows by dashed lines, the orientation of opening 126 and balls 128a and 129a after alignment of knives 10 and 100. The ball 29a of the first knife 10 moves into the opening 128d of the second knife 100. The ball 28a of the first knife 10 moves into the opening 128b of the second knife 100. FIG. 9D shows by dashed lines, both the orientation of opening 26, protruding portion 126, openings 128a-d, and balls 28a and 29a.

FIG. 11 shows the second knife 100 on top of and connected to the first knife 10, by the method shown by FIGS. 9A-9D. Ball 29a of the first knife 10 is shown in dashed lines inserted into the opening 128d of the second knife 100. Ball 28 is shown in dashed lines inserted into the opening 128b of the second knife 100. The portion 126a of the protrusion 126 of the second knife 100 is shown inserted into plate 92 of the first knife 10 and the portion 126b is shown inserted into plate 11 of the first knife 10.

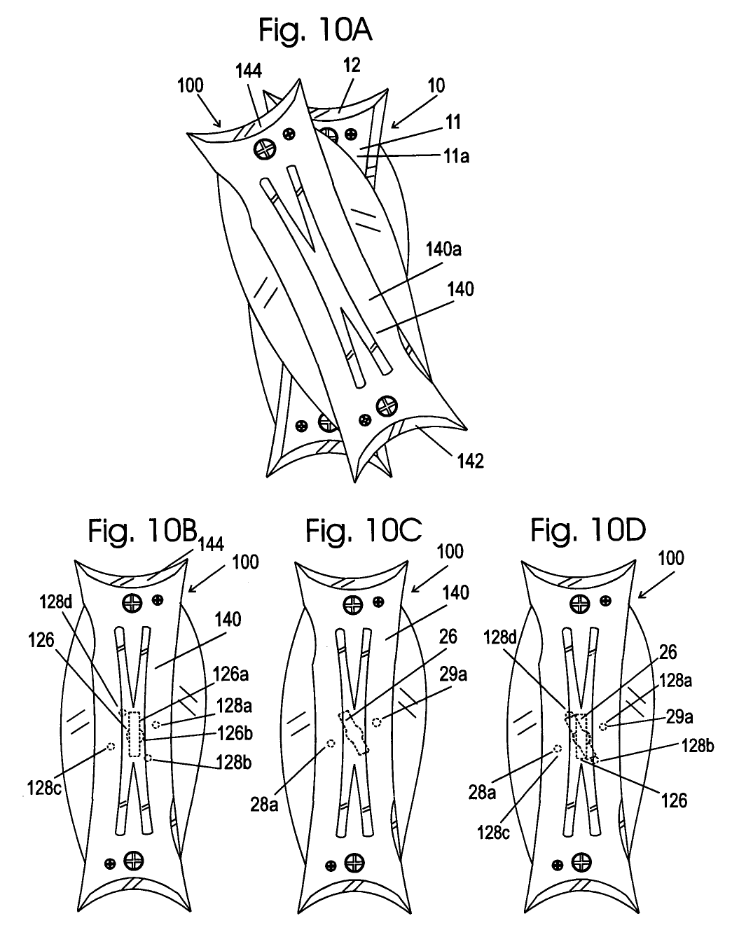

The arrangement of the four openings 128a-d allows the second knife 100 to be placed over the first knife 10 in a second manner as shown in FIG. 10A. FIGS. 10A-10D are similar to FIGS. 9A-9D, with the exception that in FIG. 10A the second knife 100 is placed so that the portion 144 is closer to the portion 12 of the first knife 10 than portion 142, while in FIG. 8A the portion 142 is closer to the portion 12 of the first knife 10. For the arrangement and method of FIG. 10A-10D, the balls 29a and 28a will move into the holes 128a and 128c, respectively, in order to align the second knife 100 with the first knife 10.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

1. An apparatus comprising:
a first knife;
a second knife;
wherein the first knife includes a first attachment device;
wherein the second knife includes a second attachment device;
wherein the first attachment device and the second attachment device can be attached to each other to attach the first knife to the second knife; and
wherein the first attachment device and the second attachment device can be detached from each other to detach the first knife from the second knife.

2. The apparatus of claim 1 wherein
the first knife is a switch blade type knife; and
the second knife is a folding type knife.

3. The apparatus of claim 2 wherein
the first knife is comprised of first and second blades; and
the second knife is comprised of third and fourth blades.

4. The apparatus of claim 1 further wherein
the first attachment device is comprised of a first plate having an opening;
the second attachment device is comprised of a protrusion; and
wherein the protrusion of the second attachment device can be inserted into the opening of the first plate to attach the first knife to the second knife.

5. The apparatus of claim 1 further wherein
the second attachment device is comprised of a second plate attached to the protrusion.

6. The apparatus of claim 5 wherein
the first attachment device is comprised of a third plate having an opening which is substantially aligned with the opening of the first plate, and wherein the protrusion can be inserted into the opening of the third plate to attach the first knife to the second knife.

7. The apparatus of claim 4 wherein
the opening in the first plate of the first attachment device has a first substantially rectangular portion, a substantially circular portion, and a second substantially rectangular portion.

8. The apparatus of claim 6 further comprising
first and second protruding stops;
wherein the first and second protruding stops protrude into the opening of the third plate of the first attachment device and prevent the first knife from rotating more than one hundred and eighty degrees with respect to the second knife, after the second knife is attached to the first knife.

9. The apparatus of claim 3 wherein
the first and second blades can rotate from a closed position within the first knife to an open position;
and wherein the third and fourth blades can rotate from a closed position within the first knife to an open position.

10. The apparatus of claim 1 wherein
the first knife has a clip.

11. The apparatus of claim 1 wherein
the second attachment device can be inserted into the first attachment device, when the first knife is place at an angle with respect to the second knife, and
wherein the first knife can be rotated with respect to the second knife to cause the first and second knife to lock in a state of alignment with respect to each other.

12. The apparatus of claim 5 wherein
first and second rotating balls are attached to the first plate, so that the balls can rotate but remain in the same position;
the second plate includes a first ball opening and a second ball opening; and
wherein the first rotating ball can be inserted into the first ball opening and the second rotating ball can be inserted into the second ball opening in order to lock the first knife in a first position with respect to the second knife.

13. The apparatus of claim 12 wherein
the second plate includes a third ball opening and a fourth ball opening; and
wherein the first rotating ball can be inserted into the third ball opening and the second rotating ball can be inserted into the fourth ball opening in order to lock the first knife in a second position with respect to the second knife; and
wherein the first position differs from the second position.

14. A method comprising the step of:
attaching a first attachment device of a first knife to a second attachment device of a second knife, in order to attach the first knife and the second knife together; and
detaching the first attachment device of the first knife from the second attachment device of the second knife in order to detach the first knife from the second knife.

15. The method of claim 14 wherein
the first knife is a folding type knife; and
the second knife is a folding type knife.

16. The method of claim 15 further wherein
the first knife is comprised of first and second blades; and
the second knife is comprised of third and fourth blades.

17. The method of claim 15 further wherein
the first attachment device is comprised of a first plate having an opening;
the second attachment device is comprised of a protrusion; and
and further comprising inserting the protrusion of the second attachment device into the opening of the first plate to attach the first knife to the second knife.

18. The method of claim 17 wherein
the second attachment device is comprised of a second plate attached to the protrusion.

19. The method of claim 18 wherein
the first attachment device is comprised of a third plate having an opening, which is substantially aligned with the opening of the first plate, and further comprising
inserting the protrusion into the opening of the third plate to attach the first knife to the second knife.

20. The method of claim 17 wherein
the opening in the first plate of the first attachment device has a first substantially rectangular portion, a substantially circular portion, and a second substantially rectangular portion.

21. The method of claim 19 further comprising
inserting first and second protruding stops into the opening of the third plate of the first attachment device;
wherein the first and second protruding stops prevent the first knife from rotating more than one hundred and eighty degrees with respect to the second knife, after the second knife is attached to the first knife.
